(19) United States
(12) Patent Application Publication
(10) Pub. No.: US 2010/0035997 A1
(43) Pub. Date: Feb. 11, 2010

(54) KIT FOR APPLYING A POLYMERIZABLE ADHESIVE COMPOSITION TO TISSUES

(76) Inventors: Kenneth N. Broadley, County Kildare (IE); John Guthrie, County Kildare (IE); Noeleen Swords, Kiltipper (IE)

Correspondence Address: HENKEL CORPORATION, One Henkel Way, ROCKY HILL, CT, 06067, US

(21) Appl. No.: 12/579,024

(22) Filed: Oct. 14, 2009

Related U.S. Application Data
(63) Continuation of application No. PCT/EP2008/054346, filed on Apr. 10, 2008.

(30) Foreign Application Priority Data
Apr. 20, 2007 (DE) 102007019044.3

(51) Int. Cl. A01N 33/12; A01N 31/02; A01N 31/08; A01N 37/52; A01P 1/00

(52) U.S. Cl. 514/635; 514/724; 514/738; 514/731; 514/642

(57) ABSTRACT

The invention relates to a kit for the topical and/or internal application of a polymerisable adhesive composition to tissues, enabling improved control of the polymerisation speed on the surface of the tissue, in addition to the effective disinfection of the wound. The kit consists of at least one receptacle and contains a polymerisable adhesive composition based on cyanacrylate, in addition to a disinfectant composition.

### CROSS REFERENCE TO RELATED APPLICATIONS

This application is a continuation under 35 U.S.C. Sections 365(c) and 120 of International Application No. PCT/EP2008/054346, filed Apr. 10, 2008 and published on Oct. 30, 2008 as WO 2008/128903, which claims priority from German Patent Application No. 102007019044.3 filed Apr. 20, 2007, which are incorporated herein by reference in their entirety.

The present invention relates to a kit for topical and/or internal application of a polymerizable adhesive composition to tissues of mammals, which kit permits not only effective wound disinfection but also improved control of the polymerization rate on the tissue surface. The kit, made up of one or more containers, contains a composition having a disinfecting action as well as a polymerizable cyanoacrylate-based adhesive composition.

### BACKGROUND OF THE INVENTION

Because of their ease of application and rapid curing rate, and the strength of the resulting adhesive bond, cyanoacrylate-based polymerizable adhesive compositions have become widely used in both industrial and medical applications. It is known that monomeric forms of cyanoacrylates are extremely reactive and polymerize rapidly in the presence of even the smallest quantities of a polymerization initiator, including moisture contained in the air or present on surfaces. Polymerization is initiated by anions, free radicals, zwitterions, or ion pairs. Once polymerization has been initiated, the curing rate can be very high. Cyanoacrylate-based polymerizable adhesive compositions have therefore proven to be attractive solutions, for example, for joining plastics, rubber, glass, metals, wood, and more recently also biological tissues. Medical applications of cyanoacrylate-based adhesive compositions include utilization both as alternatives to or in addition to surgical sutures and staples when closing wounds, and utilization to cover and protect superficial wounds such as lacerations, abrasions, burns, stomatitis, inflammations, and other open superficial wounds.

As compared with the utilization of sutures or staples for wound care, the alternative use of cyanoacrylate-based wound adhesives offers a number of advantages. Wound sutures in the direct vicinity of the injury being treated cause additional injuries because of the penetration of the needle into the tissue and the need in some cases to administer an anesthetic, and require a time-consuming procedure for application. The same is true of to wound treatment using staples. The result is that the use of these agents presents problems especially in pediatric cases, since because of the adverse effects associated with them, they trigger severe anxiety and aversion reactions in the often very young patients.

The problems set forth above can be at least partially circumvented or mitigated by the inherently painless application of a cyanoacrylate-based wound adhesive in accordance with a method described by Halpern in U.S. Pat. No. 3,667,472 or by Banitt et al. in U.S. Pat. No. 3,559,652.

In the context of medical utilization of a cyanoacrylate-based adhesive composition, application is usually accomplished in monomeric form. Subsequent anionic in-situ polymerization directly on the tissue surface then causes wound adhesion or coverage.

Controlling the polymerization rate by adding additives has proven to be critical in the context of this operation. As described in European Patent EP-B1-1073484 of Narang et al., excessively rapid polymerization may cause severe damage to the relevant tissue because of its exothermic nature and the associated evolution of heat. A reduction in the polymerization rate can be achieved by adding a variety of inhibitors. Anionic polymerization inhibitors are as a rule, but not exclusively, Lewis acids such as, for example, sulfur dioxide, nitrogen monoxide, or boron trifluoride, or inorganic or organic Brønstedt acids such as, for example, sulfuric acid, phosphoric acid, or sulfonic acids.

The polymerization rate is also reduced by pretreatment of the wound site (removing tissue fluids or wound fluids, and therefore moisture, from the region to be treated). This step of wound cleaning and disinfection, which is often medically indicated, can cause treatment to be unnecessarily delayed or complicated by excessively slow polymerization of the adhesive composition, making it necessary to add a polymerization initiator or promoter.

For example, Dombrowski et al. describe in U.S. Pat. No. 4,042,442 the addition of a polymerization initiator (caffeine or theobromine) by either mixing the adhesive composition with the initiator directly prior to application, or distributing the initiator in a volatile solvent having a boiling point below 100° C., on a variety of substrates such as, for example, metal-metal, metal-plastic, or plastic-plastic surfaces. After evaporation of the solvent, the adhesive composition is applied and polymerization occurs.

Another possibility for adding a polymerization initiator or modifier to an adhesive composition is disclosed in European Patent EP-B1-1,073,484. Here a polymerization initiator or modifier is dissolved or dispersed in a low-boiling solvent and applied onto the tip of a specially designed administration apparatus. After evaporation of the solvent, the tip of the administration apparatus allows effective mixing of the polymerization initiator/modifier with the cyanoacrylate-based adhesive composition. Mixing of the initiator with the adhesive composition in the physically very limited tip presents the latent danger that an inherently negligible amount of prematurely initiating polymerization will cause a reduction or inhibition of the flow of adhesive composition onto the tissue being treated. This can complicate or prevent reliable wound care.

In addition to effective control of the polymerization rate, the use of cyanoacrylate compositions in many medical application sectors often requires that the wound adhesive be sterile. Sterilization of the adhesive composition is, however, often difficult to achieve regardless of the type and number of additives. Common sterilization methods such as sterilization using dry and moist heat, ionizing radiation, exposure to gas, and sterile filtration are, for example, often not suitable for use with monomeric cyanoacrylate compositions. Problems occur principally due to polymerization of the monomer during the sterilization process. In many cases the polymerization initiated by sterilization is so severe than the resulting product is not usable.

It may therefore be opportune in some cases to improve the antimicrobial action of the cyanoacrylate composition by adding an antimicrobial active substance. As described in European Patent EP-B1-0856318, however, high concentrations of the antimicrobial active substance in the adhesive composition can cause a number of problems, such as initiation of premature polymerization or polymerization inhibition. The properties of the resulting polymeric films are also often degraded in terms of bendability and flexibility. It would therefore be desirable if the concentration of antimicrobial active substances in the adhesive composition could be kept as low as possible. On the other hand, it is of paramount importance in any wound treatment to avoid any risk of infection. This requires, among other things, keeping the wound surface and wound environment free of moisture, in which germs are preferentially present or can proliferate. Long-lasting antimicrobial protection of the wound surface and wound environment is likewise desirable.

The object that accordingly results for the present invention is that of making available a cyanoacrylate-based polymerizable adhesive composition that permits, in the treatment of tissue injuries, both control of the polymerization rate and long-lasting effective disinfection of the wound location.

It has now been found, surprisingly, that the present object can be achieved by making available a kit for topical and/or internal application onto tissue of mammals, the tissue by preference being surgically cut or traumatically lacerated tissue.

The kit, made up of one or more containers, allows cleaning and disinfection of the wound surface in a simple method, a specific quantity of a polymerization initiator being applied onto the surgically cut or traumatically lacerated tissue. A polymerizable adhesive composition is then applied onto the tissue surface that is now disinfected and pretreated with a specific quantity of a polymerization initiator, thereby achieving effective control of the polymerization rate, the polymerization energy released, and the tissue region on which polymerization takes place.

For this purpose, the kit for topical and/or internal application of a polymerizable adhesive composition contains, in one or more containers, a) a composition having a disinfecting action that encompasses at least one component that is selected from the polymerization initiators and is suitable for initiating and/or accelerating a polymerization of the polymerizable adhesive composition on the tissue surface, and b) a polymerizable adhesive composition.

The polymerizable adhesive composition by preference contains, as one component, a cyanoacrylate monomer according to formula (I) or a mixture of a cyanoacrylate monomer according to formula (I) with further cyanoacrylates, R being a substituted or unsubstituted, straight-chain, branched or cyclic allyl, alkoxylalkyl, alkyl, alkenyl, haloalkyl, or alkinyl group that encompasses 1 to 18 C atoms, preferably 5 to 12 C atoms, and/or contains an aromatic group or acyl group.

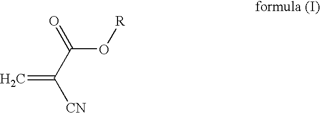

Preferred embodiments encompass, without being limited thereto, allyl-2-cyanoacrylate, beta-methoxyethyl-2-cyanoacrylate, methyl-2-cyanoacrylate, ethyl-2-cyanoacrylate, n-propyl-2-cyanoacrylate, isopropyl-2-cyanoacrylate, n-butyl-2-cyanoacrylate, isobutyl-2-cyanoacrylate (such as 1-butyl and 2-butyl), n-pentyl-2-cyanoacrylate, isopentyl-2-cyanoacrylate (such as 1-pentyl, 2-pentyl, and 3-pentyl), cyclopentyl-2-cyanoacrylate, n-hexyl-2-cyanoacrylate, isohexyl-2-cyanoacrylate (such as 1-hexyl, 2-hexyl, 3-hexyl, and 4-hexyl), cyclohexyl-2-cyanoacrylate, n-heptyl-2-cyanoacrylate, isoheptyl-2-cyanoacrylate (such as 1-heptyl, 2-heptyl, 3-heptyl, and 4-heptyl), cycloheptyl-2-cyanoacrylate, n-octyl-2-cyanoacrylate, 1-octyl-2-cyanoacrylate, 2-octyl-2-cyanoacrylate, 3-octyl-2-cyanoacrylate, 4-octyl-2-cyanoacrylate, decyl-2-cyanoacrylate, dodecyl-2-cyanoacrylate or lactoyl-2-cyanoacrylate, methoxyisopropyl-2-cyanoacrylate, ethoxyethyl-2-cyanoacrylate, isopropoxyethyl-2-cyanoacrylate, and 2-butoxyethyl-2-cyanoacrylate, and combinations of the aforesaid cyanoacrylates. n-Butyl-2-cyanoacrylate, n-octyl-2-cyanoacrylate, and/or 2-octyl-2-cyanoacrylate are to be regarded as particularly preferred exemplifying embodiments.

Regardless of its inherently present bacteriostatic action, the polymerizable adhesive composition can be sterilized, directly after production and/or after packaging, using a method selected, by way of example, from heat, ultrafiltration, and irradiation, or using a combination of the aforesaid methods.

In a preferred embodiment of the invention the kit further contains a composition having a disinfecting action, which contains as a disinfecting component one or more organic alcohols, the weight proportion of the organic alcohol based on the total quantity of the composition having a disinfecting action being at least 80%, preferably at least 90%, particularly preferably at least 95%, and particularly preferably at least 98%. Prior to application of the polymerizable adhesive composition, the composition having a disinfecting action is distributed over the tissue surface in order to bring about thereon cleaning and/or disinfection of the tissue regions to be treated.

The organic alcohols according to the present invention are by preference alcohols having 1 to 5, in particular having 1 to 3 OH groups and having 2 to 5, in particular having 2, 3, or 4 C atoms directly joined to one another. Particularly preferred exemplifying embodiments are, without being limited thereto, ethanol, n-propanol, isopropanol, n-butanol, 2-butanol, isobutanol, 1,3-butanediol, phenoxyethanol, 1,2-propylene glycol, and glycerol, and mixtures of the aforesaid alcohols.

In a preferred embodiment, the composition having a disinfecting action that is contained in the kit according to the present invention is present in the form of a liquid, as a gel, as a suspension, or as a paste in which the polymerization initiator is dispersed and/or dissolved, by preference at room temperature.

Polymerization initiators that are contained according to the present invention are by preference substances that have a pKₐ value≧5, preferably a pKₐ value between 5 and 30, or are notable for a pKₐ value<5 but possess a sufficiently highly nucleophilic nature to initiate polymerization of the polymerizable adhesive composition on the tissue surface. A polymerization initiator that satisfies these requirements causes the polymerization process to proceed by preference at a proportion of at least 90%, in accordance with an anionic or zwitterionic mechanism.

With regard to the definition of the respective pKₐ value, reference is preferably made to Landoldt-Boernstein, 6^{th} edition, volume II, pages 900ff.

The aforesaid polymerization initiators are preferably selected from aluminates, borates, carbonates, bicarbonates, carboxylates, hydroxides, halides, oxides, sulfonates, sulfates, stearates, pyrazines, amino acids, nucleophilic nonionic amines, amides, acetates, phosphines, phosphites, ammonium compounds, or nonionic surfactants, and particularly preferably from ammonium acetate, sodium bicarbonate, calcium bicarbonate, sodium carbonate, calcium carbonate, diethyl carbonate, sodium stearate, calcium stearate, polyethylene glycol stearate, pyrazine, 2,3-dimethoxypyrazine, 2,3-dimethylpyrazine, 2,5-dimethylpyrazines, trimethylpyrazine, 2-methoxy-3-methylpyrazine, arginine, histidine, phenylalanine, serine, sodium salicylate, caffeine, dimethylparatoluidine, urea, tetrabutylammonium acetate, triphenylphosphine, triethyl phosphite, ethyldiphenylphosphonite, 2-methoxypyridine, 2,2-dipyridyl disulfide, 3,5-dichloropyridine, 3,5-dibromopyridine, 4-cyanopyridine, domiphen bromide, butyrylcholine chloride, nutyrylcholine chloride, benzylalkonium bromide, benzylalkonium chloride, acetylquinoline chloride, dimethyldioctylammonium chloride/bromide, dimethyldidecylammonium chloride/bromide, dimethyldidodecylammonium chloride/bromide, or polysorbate. The use of mixtures of the aforesaid polymerization initiators is likewise preferred.

In a particularly preferred embodiment, the polymerization initiator itself possesses an antimicrobial action. Suitable test methods for determining the antimicrobial action of a substance are well known to one skilled in the art. These can be, for example, without limitation thereto, an agar diffusion test, a suspension or challenge test, or a test according to the Japanese standard methods JIS L 1902:1998 and JIS L 1902:2002.

The kit according to the present invention can by preference also contain one or more antimicrobial active substances in a quantity from usually 0.0001 to 3 wt %, by preference 0.0001 to 2 wt %, in particular 0.0002 to 1 wt %, particularly preferably 0.0002 to 0.2 wt %, and extremely preferably 0.0003 to 0.1 wt %, based in each case on the total quantity of the composition having a disinfecting action. Antimicrobial active substances are differentiated, depending on the antimicrobial spectrum and mechanism of action, between bacteriostatics and bactericides, and fungistatics and fungicides. Important substances from these groups are, for example, benzalkonium chlorides, alkylarylsulfonates, halophenols, and phenol mercuric acetate. The terms “antimicrobial action” and “antimicrobial active substance” have, in the context of the teaching of the present invention, the meaning usual in the art. Suitable antimicrobial active substances are by preference selected from the groups of the alcohols, amines, aldehydes, antimicrobial acids and salts thereof, carboxylic acid esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propylbutylcarbamate, iodine, iodophores, peroxo compounds, halogen compounds, and any mixtures of the aforesaid.

The antimicrobial active substance is preferably selected from undecylenic acid, benzoic acid, salicylic acid, dihydroacetic acid, o-phenylphenol, N-methylmorpholinoacetonitrile (MMA), 2-benzyl-4-chlorophenol, 2,2′-methylenebis-(6-bromo-4-chlorophenol), 4,4′-dichloro-2′-hydroxydiphenylether (diclosan), 2,4,4′-trichloro-2′-hydroxydiphenylether (triclosan), chlorhexidine, N-(4-chlorophenyl)-N-(3,4-dichlorophenyl)urea, N,N′-(1,10-decanediyldi-1-pyridinyl-4-ylidene)-bis-(1-octaneamine) dihydrochloride, N,N′-bis-(4-chlorophenyl)-3,12-diimino-2,4,11,13-tetraazatetradecanediimide-amide, glucoprotamines, antimicrobial surface-active quaternary compounds, guanidines including the bi- and polyguanidines such as, for example, 1,6-bis-(2-ethylhexylbiguanidohexane) dihydrochloride, 1,6-di-(N1,N1′-phenyldiguanido-N5,N5′-)hexane tetrahydrochloride, 1,6-di-(N1,N1′-phenyl-N1,N1-methyldiguanido-N5,N5′-)hexane dihydrochloride, 1,6-di-(N1,N1′-o-chlorophenyldiguanido-N5,N5′-)hexane dihydrochloride, 1,6-di-(N1,N1′-2,6-dichlorophenyldiguanido-N5,N5′-)hexane dihydrochloride, 1,6-di-[N1,N1′-beta-(p-methoxyphenyl-)diguanido-N5,N5′-]hexane dihydrochloride, 1,6-di-(N1,N1′-alpha-methyl-beta-phenyldiguanido-N5, N5′-)hexane dihydrochloride, 1,6-di-(N1,N1′-p-nitrophenyldiguanido-N5, N5′-)hexane dihydrochloride, omega:omega-di-(N1,N1′-phenyldiguanido-N5, N5′-)di-n-propyl ether dihydrochloride, omega:omega′-di-(N1,N1′-p-chlorophenyldiguanido-N5,N5′-)di-n-propyl ether tetrahydrochloride, 1,6-di-(N1,N1′-2,4-dichlorophenyldiguanido-N5, N5′-)hexane tetrahydrochloride, 1,6-di-(N1,N1′-p-methylphenyldiguanido-N5, N5′-)hexane dihydrochloride, 1,6-di-(N1,N1′-2,4,5-trichlorophenyldiguanido-N5, N5′-)hexane tetrahydrochloride, 1,6-di-[N1, N1′-alpha-(p-chlorophenyl)ethyldiguanido-N5,N5′-]hexane dihydrochloride, omega:omega-di-(N1,N1′-p-chlorophenyldiguanido-N5,N5′-)m-xylene dihydrochloride, 1,12-di-(N1,N1′-p-chlorophenyldiguanido-N5, N5′-)dodecane dihydrochloride, 1,10-di-(N1,N1′-phenyldiguanido-N5, N5′-)decane tetrahydrochloride, 1,12-di-(N1,N1′-phenyldiguanido-N5, N5′-)dodecane tetrahydrochloride, 1,6-di-(N,N1′-o-chlorophenyldiguanido-N5,N5′-)hexane dihydrochloride, 1,6-di-(N1,N1′-o-chlorophenyldiguanido-N5,N5′-)hexane tetrahydrochloride, ethylenebis-(1-tolylbiguanide), ethylenebis-(p-tolylbiguanide), ethylenebis-(3,5-dimethylphenylbiguanide), ethylenebis-(p-tert-amylphenylbiguanide), ethylenebis-(nonylphenylbiguanide), ethylenebis-(phenylbiguanide), ethylenebis-(N-butylphenylbiguanide), ethylenebis-(2,5-diethoxyphenylbiguanide), ethylenebis-(2,4-dimethylphenylbiguanide), ethylenebis-(o-diphenylbiguanide), ethylenebis-(mixed amylnaphthylbiguanide), N-butylethylenebis-(phenylbiguanide), trimethylenebis(o-tolylbiguanide), N-butyltrimethylenebis-(phenylbiguanide) and the corresponding salts such as acetates, gluconates, hydrochlorides, hydrobromides, citrates, bisulfites, fluorides, polymaleates, n-cocoalkylsarcosinates, phosphites, hypophosphites, perfluoroctanoates, silicates, sorbates, salicylates, maleates, tartrates, fumarates, ethylendiamintetraacetates, iminodiacetates, cinnamates, thiocyanates, arginates, pyromellitates, tetracarboxybutyrates, benzoates, glutarates, monofluorphosphates, perfluorpropionates, and any mixtures thereof. Also suitable are halogenated xylene and cresol derivatives such as p-chlorometacresol or p-chlorometaxylene, as well as natural antimicrobial active substances of vegetable origin (e.g. from spices or herbs), or animal or microbial origin. It is preferable to use antimicrobially active surface-active quaternary compounds, a natural antimicrobial active substance of vegetable origin, and/or a natural antimicrobial active substance of animal origin, extremely preferably at least one natural antimicrobial active substance of vegetable origin from the group encompassing caffeine, theobromine, and theophylline, as well as essential oils such as eugenol, thymol, and geraniol, and/or at least one natural antimicrobial active substance of animal origin from the group encompassing enzymes such as protein from milk, lysozyme, and lactoperoxidase, and/or at least one antimicrobially acting surface-active quaternary compound having an ammonium, sulfonium, phosphonium, iodonium, or arsonium group, peroxo compounds, and chlorine compounds. Substances of microbial origin (so-called bacteriocins) may also be used. Glycine, glycine derivatives, formaldehyde, compounds that readily release formaldehyde, formic acid, and peroxides are used by preference.

Betadine®, chlorhexidine, and quaternary ammonium compounds (QACs) are particularly preferred as antimicrobial active substances.

The quaternary ammonium compounds (QACs) have the general formula (R1)(R2)(R3)(R4)N+X—, in which R1 to R4 represent identical or different C1-C22 alkyl radicals, C7-C28 aralkyl radicals, or heterocyclic radicals, two or (in the case of an aromatic bond such as in pyridine) even three radicals forming the heterocycle together with the nitrogen atom, for example, a pyridinium or imidazolinium compound; and X⁻ is halide ions, sulfate ions, hydroxide ions, or similar anions. For an optimum antimicrobial action, at least one of the radicals preferably has a chain length from 8 to 18, in particular 12 to 16, C atoms.

QACs can be produced by the reaction of tertiary amines with alkylating agents such as, for example, methyl chloride, benzyl chloride, dimethyl sulfate, dodecyl bromide, but also ethylene oxide. The alkylation of tertiary amines having a long alkyl radical and two methyl groups is particularly easy; in addition, the quaternization of tertiary amines having two long radicals and one methyl group can be carried out using methyl chloride under mild conditions. Amines that possess three long alkyl radicals or hydroxy-substituted alkyl radicals are less reactive, and are preferably quaternized using dimethyl sulfate.

Suitable QACs are, for example, benzalkonium chloride (N-alkyl-N,N-dimethylbenzylammonium chloride, CAS No. 8001-54-5), benzalkon B (m,p-dichlorobenzyldimethyl-C₁₋₂-alkylammonium chloride, CAS No. 58390-78-6), benzoxonium chloride (benzyldodecyl-bis-(2-hydroxyethyl)ammonium chloride), cetrimonium bromide (N-hexadecyl-N,N-trimethylammonium bromide, CAS No. 57-09-0), benzethonium chloride (N,N-dimethyl-N-[2-[2-[p-(1,1,3,3-tetramethylbutyl)phenoxy]ethoxy]ethyl]benzylammonium chloride, CAS No. 121-54-0), dialkyldimethylammonium chlorides such as di-n-decyldimethylammonium chloride (CAS No. 7173-51-5-5), didecyldimethylammonium bromide (CAS No. 2390-68-3), dioctyidimethylammonium chloride, 1-cetylpyridinium chloride (CAS No. 123-03-5), and thiazoline iodide (CAS No. 15764-48-1), as well as mixtures thereof. Particularly preferred QACs are the benzalkonium chlorides having C8-C18 alkyl radicals, in particular C12-C14 alkylbenzyldimethylammonium chloride.

Benzalkonium halides and/or substituted benzalkonium halides are obtainable commercially, for example, as Barquat® from Lonza, Marquat® from Mason, Variquat® from Witco/Sherex, and Hyaminee from Lonza, as well as Bardac® from Lonza. Further commercially obtainable antimicrobial active substances are N-(3-chlorallyl)hexaminium chloride such as Dowicide® and Dowicil® from Dow, benzethonium chloride such as Hyamine® 1622 from Rohm & Haas, methylbenzethonium chloride such as Hyamine® 10× from Rohm & Haas, and cetylpyridinium chloride such as Cepacol chloride from Merrell Labs.

An additional advantage is achieved by the particularly preferred use of quaternary ammonium compounds (QACs) as polymerization initiators that are present in dispersed and/or dissolved fashion in the composition having a disinfecting action in the kit according to the present invention. After evaporation of the composition having a disinfecting action, for example, 2-propanol, a residue of the antimicrobially active quaternary ammonium compounds remains behind on the tissue surface. This protective residue causes the relevant tissue portion to be exposed to a reduced risk of infection during treatment, since antimicrobial protection of the exposed tissue surface exists even after evaporation of the disinfecting alcohols and prior to application of the polymerizable adhesive composition. A considerably better protective effect with respect to Gram-positive and Gram-negative bacteria on the affected and surrounding tissue portions can therefore be achieved, even with longer treatment times, because of the preferred application of quaternary ammonium compounds. Additional infection protection of this kind does not exist with the conventional treatment method, since after evaporation of the composition having a disinfecting action, recontamination of the wound by external influences, for example, because of inadequate sterility of the persons performing treatment or the equipment used for treatment, cannot be ruled out.

In combination with the pretreatment of the tissue surface using a composition having a disinfecting action, in which, in addition to disinfection of the affected tissue regions, tissue fluid is also removed, a further advantage is achieved in terms of controlling polymerization of the adhesive composition. The exclusion of moisture allows the necessary quantity of polymerization initiator to be better determined, since the amount of polymerization initiated by the moisture can be minimized. A greater degree of control of the polymerization reaction is thus achieved, thereby avoiding tissue damage due to excessive heat evolution at high polymerization rates.

In a preferred embodiment of the invention, the kit furthermore contains at least one further component selected from the groups of the plasticizers, thickening agents, stabilizers, skin-care active substances, perfumes, wound healing agents, coloring substances, heat-dissipating reagents, primers, and/or anti-inflammatory agents.

Triaryl or trialkyl phosphates and ester compounds are particularly suitable as plasticizers according to the present invention. The alcohol component of the ester involves, by preference, alcohols having 1 to 5, in particular 2 to 4, OH groups and having 2 to 5, in particular 3 or 4 C atoms joined directly to one another. The number of C atoms not directly joined to one another can be up to 110, in particular up to 18 C atoms.

The following substances are suitable as monovalent alcohols: methanol, ethanol, 1-propanol, 2-propanol, 1-butanol, 2-butanol, 2,2-dimethyl-1-propanol, 2-methyl-1-propanol, 2,2-dimethyl-1-propanol, 2-methyl-2-propanol, 2-methyl-1-butanol, 3-methyl-1-butanol, 2-methyl-2-butanol, 3-methyl-2-butanol, 1-pentanol, 2-pentanol, 3-pentanol, cyclopentanol, cyclopentenol, glycidol, tetrahydrofurfuryl alcohol, tetrahydro-2H-pyran-4-ol, 2-methyl-3-buten-2-ol, 3-methyl-2-buten-2-ol, 3-methyl-3-buten-2-ol, 1-cyclopropylethanol, 1-penten-3-ol 3-penten-2-ol, 4-penten-1-ol, 4-penten-2-ol, 3-pentin-1-ol, 4-pentin-1-ol, propargyl alcohol, allyl alcohol, hydroxyacetone, 2-methyl-3-butin-2-ol.

Suitable as divalent alcohols are, for example: 1,2-ethanediol, 1,2-propanediol, 1,3-propanediol, dihydroxyacetone, thioglycerol, 2-methyl-1,3-propanediol, 2-butine-1,4-diol, 3-butene-1,2-diol, 2,3-butanediol, 1,4-butanediol, 1,3-butanediol, 1,2-butanediol, 2-butene-1,4-diol, 1,2-cyclopentanediol, 3-methyl-1,3-butanediol, 2,2-dimethyl-1,3-propanediol, 4-cyclopentene-1,3-diol, 1,2-cyclopentanediol, 2,2-dimethyl-1,3-propanediol, 1,2-pentanediol, 2,4-pentanediol, 1,5-pentanediol, 4-cyclopentene-1,3-diol, 2-methylene-1,3-propanediol, 2,3-dihydroxy-1,4-dioxane, 2,5-dihydroxy-1,4-dithiane.

The following trivalent alcohols can be used: glycerol, erythrulose, 1,2,4-butanetriol, erythrose, threose, trimethylolethane, trimethylolpropane, and 2-hydroxymethyl-1,3-propanediol.

Of the tetravalent alcohols, for example, erythritol, threitol, pentaerythritol, arabinose, ribose, xylose, ribulose, xylulose, lyxose, ascorbic acid, gluconic acid-γ-lactone can be used.

Examples of pentavalent alcohols that may be cited are arabitol, adonitol, xylitol.

Further suitable mono- and polyvalent alcohols are familiar to one skilled in the art.

The polyvalent alcohols described above can also be used, for example, in the form of ethers. The ethers can be produced from the aforementioned alcohols, for example, by way of condensation reactions, Williamson ether synthesis, or by reaction with alkylene oxides such as ethylene, propylene, or butylene oxide. Examples that may be cited are: diethylene glycol, triethylene glycol, polyethylene glycol, diglycerol, triglycerol, tetraglycerol, pentaglycerol, polyglycerol, technical mixtures of the condensation products of glycerol, glycerol propoxylate, diglycerol propoxylate, pentaerythritol ethoxylate, dipentaeryrthritol, ethylene glycol monobutyl ether, propylene glycol monohexyl ether, butyldiglycol, dipropylene glycol monomethyl ether.

Monovalent carboxylic acids that can be used for esterification with the aforementioned alcohols are, for example: formic acid, acrylic acid, acetic acid, propionic acid, butyric acid, isobutyric acid, valeric acid, isovaleric acid, 2-oxovaleric acid, 3-oxovaleric acid, pivalic acid, acetoacetic acid, levulinic acid, 3-methyl-2-oxobutyric acid, propiolic acid, tetrahydrofuran-2-carboxylic acid, methoxyacetic acid, dimethoxyacetic acid, 2-(2-methoxyethoxy)acetic acid, pyruvic acid, 2-methoxyethanol, vinylacetic acid, allylacetic acid, 2-pentenoic acid, 3-pentenoic acid.

The following may be mentioned as examples of polyvalent carboxylic acids: oxalic acid, malonic acid, fumaric acid, maleic acid, succinic acid, glutaric acid, acetylenedicarboxylic acid, oxaloacetic acid, acetonedicarboxylic acid, mesoxalic acid, citraconic acid, dimethylmalonic acid, methylmalonic acid, ethylmalonic acid.

Hydroxycarboxylic acids may also be used starting materials, for example, tartronic acid, lactic acid, malic acid, tartaric acid, citramalic acid, 2-hydroxyvaleric acid, 3-hydroxyvaleric acid, 3-hydroxybutyric acid, 3-hydroxyglutaric acid, dihydroxyfumaric acid, 2,2-dimethyl-3-hydroxypropionic acid, dimethylolpropionic acid, glycolic acid.

The esterification can be performed either completely or partially. Mixtures of these acids can also, if applicable, be used for esterification.

The esters produced from these alcohols and carboxylic acids or from the corresponding derivatives are by preference free of catalysts, in particular alkali metals and amines. This can be achieved by treating with esters according to the present invention with acids, ion exchangers, acetic-acid aluminas, aluminum oxides, activated carbon, or other adjuvants known to one skilled in the art. Distillation can be performed for drying and further purification.

The following may be mentioned as examples of esters particularly suitable as plasticizers: ethyl acetate, butyl acetate, glycerol triacetate, glycerol tripropionate, triglycerol pentaacetate, polyglycerol acetate, diethylene glycol diacetate, 3-hydroxyvaleric acid ethyl ester, lactic acid butyl ester, lactic acid isobutyl ester, 3-hydroxybutyric acid ethyl ester, oxalic acid diethyl ester, mesoxalic acid diethyl ester, malic acid dimethyl ester, malic acid diisopropyl ester, tartaric acid diethyl ester, tartaric acid dipropyl ester, tartaric acid diisopropyl ester, glutaric acid dimethyl ester, succinic acid dimethyl ester, succinic acid diethyl ester, maleic acid diethyl ester, fumaric acid diethyl ester, malonic acid diethyl ester, acrylic acid 2-hydroxyethyl ester, 3-oxovaleric acid methyl ester, glycerol diacetate, glycerol tributyrate, glycerol tripropionate, glycerol dipropionate, glycerol triisobutyrate, glycerol diisobutyrate, glycidyl butyrate, acetoacetic acid butyl ester, levulinic acid ethyl ester, 3-hydroxyglutaric acid dimethyl ester, glycerol acetate dipropionate, glycerol diacetate butyrate, propionic acid butyl ester, propylene glycol diacetate, propylene glycol dibutyrate, diethylene glycol dibutyrate, trimethylolethane triacetate, trimethylolpropane triacetate, trimethylolethane tributyrate, neopentyl alcohol dibutyrate, methoxyacetic acid pentyl ester, dimethoxyacetic acid butyl ester, glycolic acid butyl ester.

The aforesaid esters can be added in a quantity of up to 50 wt %, by preference in a quantity from 1 to 30 wt %, based on the total adhesive.

Further suitable plasticizers are, for example, esters such as abietic acid esters, adipic acid esters, azelaic acid esters, benzoic acid esters, butyric acid esters, acetic acid esters, esters of higher fatty acids having approximately 8 to approximately 44 C atoms, esters of fatty acids, fatty acid esters, and fats that are epoxidized or carry OH groups glycolic acid esters, phosphoric acid esters, phthalic acid esters, linear or branched alcohols containing 1 to 12 C atoms, propionic acid esters, sebacic acid esters, sulfonic acid esters, thiobutyric acid esters, trimellitic acid esters, citric acid esters, and mixtures of two or more thereof. Particularly suitable are the asymmetrical esters of difunctional aliphatic or aromatic dicarboxylic acids, for example the esterification product of adipic acid monooctyl ester with 2-ethylhexanol (Edenol DOA, Cognis, Düsseldorf) or the esterification product of phthalic acid with butanol.

Also suitable as plasticizers are the pure or mixed ethers of monofunctional linear or branched C4-16 alcohols or mixtures of two or more different ethers of such alcohols, for example dioctyl ether (obtained as Cetiol OE, Cognis, Dusseldorf).

End-capped polyethylene glycols are additionally suitable as plasticizers, for example, polyethylene or polypropylene glycol di-C1-4-alkyl ethers, in particular the dimethyl or diethyl ethers of diethylene glycol or dipropylene glycol, as well as mixtures of two or more thereof.

It is likewise a preferred embodiment of the kit according to the present invention when polymers are added to the polymerizable adhesive composition, for example in order to increase the viscosity or vary the adhesion properties. These additives serve as thickeners and influence the rheology of the adhesive mixture in the desired fashion. The polymers can be used in a quantity from 1 to 60, in particular 10 to 50, by preference 10 to 30 wt %, based on the entire formulation. Especially suitable are polymers based on vinyl ethers, vinyl esters, esters of acrylic acid and methacrylic acid having 1 to 22 C atoms in the alcohol component, styrene, and co- and terpolymers derived therefrom with ethene, butadiene. Vinyl chloride/vinyl acetate copolymers having a vinyl chloride proportion from 50 to 95 wt % are preferred.

The polymers can be present in liquid, resin-like, or even in solid form. It is particularly important that the polymers contain no contaminants from the polymerization process that inhibit curing of the cyanoacrylate-based adhesive composition.

If the polymers exhibit too high a water content, drying must be performed as applicable.

The molecular weight can vary over a broad range; it should be at least Mw=1.5 kg/mol but at most 1,000 kg/mol, since otherwise the final viscosity of the adhesive formulation is too high. Mixtures of the aforesaid polymers can also be used. In particular, the combination of low- and high-molecular weight products has particular advantages in terms of the final viscosity of the adhesive formulation. Examples of suitable vinyl acetate-based polymers that may be cited are: Mowilith grades 20, 30, and 60, Vinnapas grades B1.5, B100, B17, B5, B500/20VL, B60, UW 10, UW1, UW30, UW4, and UW50. Examples of suitable acrylate-based polymers that may be cited are: Acronal 4F and the Laromer grades 8912, PE55F, PO33F. Examples of suitable methacrylate-based polymers that may be cited are: Elvacite 2042, the Neocryl grades B 724, B999 731, B 735, B 811, B 813, B 817, and B722, Plexidon MW 134, Plexigum grades M 825, M 527, N 742, N 80, P 24, P 28, PQ 610. An example of suitable vinyl ether-based polymers that may be cited is: Lutonal A25. Cellulose derivatives and silica gel can also be used for thickening. The addition of polycyanoacrylates is especially to be emphasized.

It is known that cyanoacrylic acid esters are accessible to both anionic and radical-chain polymerization. It is therefore advisable to protect the ester compounds from both types of polymerization so that premature curing of the ester does not occur, thereby avoiding storage difficulties. The effect of these inhibitors is thus that the setting behavior is not significantly modified over a considerably extended storage period. In other words, spontaneous or even slow polymerization is quantitatively suppressed by the inhibitor or inhibitors used. Discoloration of the adhesive during storage is also prevented.

In order to prevent anionic polymerization, it is preferred to add an anionic polymerization inhibitor to the adhesive composition according to the present invention. All anionic polymerization inhibitors that have previously been used in the field of cyanoacrylic acid ester adhesives are suitable therefor. The anionic polymerization inhibitor can be, for example, an acid gas or a protonic acid or an anhydride thereof. The preferred anionic polymerization inhibitor for the adhesives according to the invention is sulfur dioxide or boron trifluoride, by preference in a quantity from 0.0001 to 5 wt %, particularly preferably in a quantity from 0.0005 to 1 wt %, and very particularly preferably in a quantity from 0.001 to 0.5 wt %, based on the total quantity of the polymerizable adhesive composition. Further usable anionic polymerization inhibitors are dinitrogen monoxide, hydrogen fluoride, hydrochloric acid, sulfuric acid, phosphoric acid, organic sulfonic and carboxylic acids and anhydrides thereof, phosphorus pentoxide, and acid chlorides. In accordance with the invention, a radical chain polymerization inhibitor can also be added to the adhesives in a quantity from 0.01 to 0.05 wt %. This radical chain polymerization inhibitor can be one of the radical chain polymerization inhibitors known for cyanoacrylate-based polymerizable adhesive compositions. Phenol compounds, for example hydroquinone, butylated hydroxyanisole (BHA), 2,6-di-tert-butyl-4-methylphenol (BHT), t-butylcatechinone, pyrocatechol, and p-methoxyphenol are usually used.

In a further preferred embodiment, the kit may contain one or more skin-care active substances. Skin-care active substances may be, in particular, those agents that impart a sensory advantage to the skin, for example, by delivering lipids and/or moisturizing factors to it and thus assisting healing of the affected tissue portion.

Skin-care active substances are known to one skilled in the art and can preferably be selected from the following substance groups, or from mixtures of the following substance groups, although without being limited thereto:
a) Waxes such as, for example, carnauba, spermaceti, beeswax, lanolin, and/or derivatives thereof, and others.
b) Hydrophobic plant extracts.
c) Hydrocarbons such as, for example, squalenes and/or squalanes.
d) Higher fatty acids, by preference those having at least 12 carbon atoms, for example lauric acid, stearic acid, behenic acid, myristic acid, palmitic acid, oleic acid, linoleic acid, linolenic acid, isostearic acid and/or polyunsaturated fatty acids, and others.
e) Higher fatty alcohols, by preference those having at least 12 carbon atoms, for example lauryl alcohol, cetyl alcohol, stearyl alcohol, oleyl alcohol, behenyl alcohol, cholesterol, and/or 2-hexadecanol, and others.
f) Esters, by preference those such as cetyl octanoates, lauryl lactates, myristyl lactates, cetyl lactates, isopropyl myristates, myristyl myristates, isopropyl palmitates, isopropyl adipates, butyl stearates, decyl oleates, cholesterol isostearates, glycerol monostearates, glycerol distearates, glycerol tristearates, alkyl lactates, alkyl citrates, and/or alkyl tartrates, and others.
g) Lipids such as, for example, cholesterol, ceramides, and/or sucrose esters, and others.
h) Vitamins such as, for example, vitamins A and E, vitamin alkyl esters, including vitamin C alkyl esters, and others.
i) Sun protection agents.
j) Phospholipids.
k) Derivatives of alpha-hydroxy acids.
l) Germicides for cosmetic use, both synthetic such as, for example, salicylic acid and/or others, and natural such as, for example, neem oil and/or others.
m) Silicones.

In a further preferred embodiment, the kit may contain perfumes as a further component. Suitable perfumes are known to one skilled in the art. Some perfumes will be recited below by way of example, although with no limitation thereto.

The term “perfume” is to be understood as perfume oils, aroma chemicals, fragrances, and odorants. “Perfume oils” is the term to be used for mixtures of natural and synthetic odorants.

Natural odorants are extracts from blossoms (lily, lavender, rose, jasmine, neroli, ylang-ylang), stems and leaves (geranium, patchouli, petitgrain), fruits (anise, coriander, caraway, juniper), fruit rinds (bergamot, lemon, orange), roots (mace, angelica, celery, cardamom, costus, iris, sweet flag), woods (pine, sandalwood, guaiac, cedar, rosewood), herbs and grasses (tarragon, lemon grass, sage, thyme, chamomile), needles and twigs (fir, spruce, pine, mountain pine), resins and balsams (galbanum, elemi, benzoin, myrrh, olibanum, opoponax).

Animal raw materials are also possible, for example civet and castoreum.

Typical synthetic odorant compounds are products of the ester, ether, aldehyde, ketone, alcohol, and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, cyclohexy salicylate, floramate, melusate, jasmecyclate, and benzyl salicylate. The ethers include, for example, benzylethyl ether and ambroxan; the aldehydes, for example, the linear alkanals having 8 to 18 carbon atoms, citral, citronellal, citronellyloxyacetaldehyde, cyclamenaldehyde, hydroxycitronellal, lilial and bourgeonal; the ketones, for example, the ionones, α-isomethylionone und methylcedryl ketone; the alcohols, anethol, citronellol, eugenol, geraniol, linalool, phenylethyl alcohol and terpineol; and the hydrocarbons include principally the terpenes such as limonene and pinene.

It is preferred, however, to use mixtures of different odorants that together produce an appealing fragrance note. Low-volatility essential oils that are usually used as aroma components are also suitable as perfume oils, for example, sage oil, chamomile oil, clove oil, lemon balm oil, mint oil, cinnamon leaf oil, linden blossom oil, juniper berry oil, vetiver oil, olibanum oil, galbanum oil, labolanum oil, and lavandin oil. Bergamot oil, dihydromyrcenol, lilial, lyral, citronellol, phenylethyl alcohol, α-hexylcinnamaldehyde, geraniol, benzyl acetone, cyclamenaldehyde, linalool, Boisambrene Forte, ambroxan, indole, Hedione, Sandelice, lemon oil, tangerine oil, orange blossom oil, orange peel oil, sandalwood oil, neroli oil, allylamyl glycolate, Cyclovertal, lavandin oil, muscatel, sage oil, β-damascone, geranium bourbon oil, cyclohexyl salicylate, Vertofix Coeur, Iso E Super, Fixolide NP, evernyl, iraldein gamma, phenylacetic acid, geranyl acetate, benzyl acetate, rose oxide, romilat, irotyl, and floramat are used by preference, alone or in mixtures.

Further examples of odorants that can be in the compositions according to the present invention can be found, for example, in S. Arctander, Perfume and Flavor Materials, Vol. I and II, Montclair, N.J., 1969 (self-published) or K. Bauer, D. Garbe, and H. Surburg, Common Fragrance and Flavor Materials, 3rd ed., Wiley-VCH, Weinheim 1997.

In order to be perceptible, an odorant must be volatile; in addition to the nature of the functional groups and the structure of the chemical compound, the molecular weight also plays an important part. Most odorants, for example, possess molecular weights of up to approximately 200 dalton, while molecular weights of 300 dalton and above represent something of an exception. Because of the differing volatility of odorants, the odor of a perfume or fragrance made up of multiple odorants changes during volatilization, the odor impressions being subdivided into a “top note,” “middle note” or “body,” and “end note” or “dry out.”

Because the perception of an odor also depends a great deal on the odor intensity, the top note of a perfume or fragrance is not made up only of highly volatile compounds, while the end note comprises for the most part less-volatile, i.e. adherent odorants.

Adherent odorants that are advantageously usable in the context of the present invention are, for example, the essential oils such as angelica oil, anise oil, arnica flower oil, basil oil, bay oil, bergamot oil, champaca flower oil, silver fir oil, silver fir cone oil, elemi oil, eucalyptus oil, fennel oil, fir needle oil, galbanum oil, geranium oil, gingergrass oil, guaiac wood oil, balsam gurjun oil, helichrysum oil, ho oil, ginger oil, iris oil, cajeput oil, calamus oil, chamomile oil, camphor oil, kanaga oil, cardamom oil, cassia oil, pine needle oil, balsam copaiva oil, coriander oil, curled peppermint oil, caraway oil, cumin oil, lavender oil, lemon grass oil, lime oil, tangerine oil, lemon balm oil, ambrefte seed oil, myrrh oil, clove oil, neroli oil, niaouli oil, olibanum oil, orange oil, oregano oil, palmarosa oil, patchouli oil, balsam peru oil, petitgrain oil, pepper oil, peppermint oil, pimento oil, pine oil, rose oil, rosemary oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, ysop oil, cinnamon oil, cinnamon leaf oil, citronella oil, lemon oil, and cypress oil.

The higher-boiling or solid odorants of natural or synthetic origin can, however, also be used advantageously in the context of the present invention as adherent odorants or odorant mixtures, i.e. fragrances. These compounds include the compounds recited below, and mixtures thereof: ambrettolide, α-amylcinnamaldehyd, anethole, anisealdehyde, anise alcohol, anisole, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerate, borneol, bornyl acetate, α-bromostyrene, n-decylaldehyde, n-dodecylaldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmone, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl naphthyl ketone, methyl-n-nonylacetaldehyde, methyl n-nonyl ketone, muscone, naphthol ethyl ether, naphthol methyl ether, nerol, nitrobenzene, n-nonylaldehyde, nonyl alcohol, n-octylaldehyde, p-oxyacetophenone, pentadecanolide, phenylethyl alcohol, phenylacetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, undelactone, vanillin, veratrumaldehyde, cinnamaldehyde, cinnamyl alcohol, cinnamic acid, cinnamic acid ethyl ester, cinnamic acid benzyl ester.

Included among the more-volatile odorants that are advantageously usable in the context of the present invention are, in particular, the lower-boiling odorants of natural or synthetic origin that can be used alone or in mixtures. Examples of more-volatile odorants are alkylsothiocyanates (alkylmustard oils), butanedione, limonene, linalool, linalyl acetate and propionate, menthol, menthone, methyl-n-heptenone, phellandrene, phenylacetaldehyde, terpinyl acetate, citral, citronellal.

All the aforementioned odorants are usable alone or in mixtures.

To the extent the kit according to the present invention contains wound healing agents, coloring substances, heat-dissipating reagents, primers, and anti-inflammatory agents, these are known to one skilled in the art and their preferred concentration can easily be determined by one skilled in the art without excessive experimentation.

One preferred area of application of the kit is the treatment of surgically cut or traumatically lacerated tissue; this refers, in particularly preferred fashion, to human skin. The kit according to the present invention is by preference used for wound coverage and/or wound closure.

The subject of the present invention is therefore also a kit according to the present invention for use in a method for treatment of surgically incised or traumatically lacerated tissue, wherein said tissue is preferably human skin.

The subject of the present invention is the kit according to the present invention for use in a method for wound coverage and/or wound closure. In a particularly preferred embodiment of the present invention, at least a portion of the composition having a disinfecting action and/or of the polymerization initiator is adsorbed on at least a portion of the composition having a disinfecting action and/or of the polymerization initiator is absorbed on a carrier material for administration, the carrier material being selected, by way of example, from the group of the fibrous and/or porous materials.

A further advantage of the kit according to the present invention is that the polymerization initiator contained in the composition having a disinfecting action not only is suitable for initiating and/or accelerating polymerization of a polymerizable adhesive composition on the tissue surface, but also causes a limitation of the flow of a monomeric adhesive composition upon application to the tissue surface.

A “limitation of flow” for purposes of the invention is a reduction of at least 1%, preferably at least 5%, particularly preferably at least 10%, very particularly preferably at least 15%, and greatly preferably at least 20%, in the run-out area of a polymerizable adhesive composition upon application onto a tissue surface, as compared with the run-out area of an identical quantity of the same polymerizable adhesive composition on an identical but untreated tissue surface.

The reduction in the run-out area of a polymerizable adhesive composition upon application onto a tissue surface can, in particular, in fact be even more considerable, and can by preference be at least 25%, at least 30%, at least 35%, at least 40%, at least 45%, or at least 50%, based in each case on the run-out area of an identical quantity of the same polymerizable adhesive composition on an identical untreated tissue surface.

A “run-out area” is to be understood for purposes of the invention as the area occupied by the polymerizable monomeric adhesive composition, after application onto a surface, until the completely cured polymer film forms. To allow any possible change in the run-out area to be determined, an identical quantity of the same polymerizable monomeric adhesive composition is distributed in each case onto respective equally-sized areas of the test body and reference body. Application of the polymerizable monomeric adhesive composition is performed so quickly, as compared with its flow rate, that any difference in the flow behavior of the polymerizable monomeric adhesive composition on different surfaces during application can be ignored.

The flow limitation brought about by the surface-modified composition results in better localization of the adhesion region, and thus produces a reduction in the total quantity of cyanoacrylate-based polymerizable monomeric adhesive composition required, and protects adjacent tissue regions from unintentional contact with the wound adhesive.

### Exemplifying Embodiments

Substances Used:

| Material | Manufacturer |
|---|---|
| n-Butyl cyanoacrylate | Henkel Dublin |
| 2-Octyl cyanoacrylate | Henkel Dublin |
| Octyl/butyl CA mixture | Henkel Dublin |
| Octyl/Butyl CA mixture | Henkel Dublin |
| 2-Propanol | Aldrich |
| 2-Methoxy-3-methylpyrazine | Aldrich |
| 2,3-Dimethylpyrazine | Aldrich |
| Skin Pad | Limbs and Things |

Procedure

1. Different solutions of a polymerization initiator in 2-propanol were produced:

| | | Concentration |
|---|---|---|
| Solution | Polymerization initiator | [wt %] |
| Initiator solution 1 | 2-Methoxy-3-methylpyrazine | 2.3 |
| Initiator solution 2 | 2,3-Dimethylpyrazine | 2.4 |

2. A Skin Pad, constituting a test surface, was pretreated/primed in four different ways:

| | |
|---|---|
| Untreated - control | A |
| Pretreated with 2-propanol | B |
| Pretreated with initiator solution 1 | C |
| Pretreated with initiator solution 2 | D |

In the case of pretreatment of the test surface with 2-propanol or a solution of an initiator in 2-propanol, a delay of at least 60 minutes was observed before applying the cyanoacrylate-based adhesive composition.

3. A 2.5-cm-long incision was made in the Skin Pad serving as the test surface in order to imitate a wound injury. The incision was filled with a sufficient quantity of a cyanoacrylate-based adhesive composition from a dropper apparatus, each experiment being performed three times.

4. The curing time of the cyanoacrylate-based adhesive composition was determined by visual impression using a stopwatch.

Results:

| Entry | | | Curing |
|---|---|---|---|
| no. | Cyanoacrylate | Conditions | time (s) |
| 1 | 2-Octyl | A | 30 |
| | | | 32 |
| | | | 26 |
| 2 | 2-Octyl | B | 25 |
| | | | 29 |
| | | | 28 |
| 3 | 2-Octyl | C | 10 |
| | | | 10 |
| | | | 10 |
| 4 | 2-Octyl | D | 12 |
| | | | 12 |
| | | | 12 |
| 5 | n-Butyl | A | 8 |
| | | | 10 |
| | | | 10 |
| 6 | n-Butyl | B | 8 |
| | | | 10 |
| | | | 8 |
| 7 | n-Butyl | C | 5 |
| | | | 5 |
| | | | 5 |
| 8 | n-Butyl | D | 5 |
| | | | 5 |
| | | | 5 |
| 9 | 2-Octyl:n-butyl CA | A | 10 |
| | mixture, 4:1 | | 10 |
| | | | 7 |
| 10 | 2-Octyl:n-butyl CA | B | 9 |
| | mixture, 4:1 | | 10 |
| | | | 7 |
| 11 | 2-Octyl:n-butyl CA | C | 5 |
| | mixture, 4:1 | | 5 |
| | | | 5 |
| 12 | 2-Octyl:n-butyl CA | D | 5 |
| | mixture, 4:1 | | 5 |
| | | | 5 |
| 13 | 2-Octyl:n-butyl CA | A | 10 |
| | mixture, 3:1 | | 10 |
| | | | 10 |
| 14 | 2-Octyl:n-butyl CA | B | 10 |
| | mixture, 3:1 | | 10 |
| | | | 12 |
| 15 | 2-Octyl:n-butyl CA | C | 6 |
| | mixture, 3:1 | | 6 |
| | | | 6 |
| 16 | 2-Octyl:n-butyl CA | D | 5 |
| | mixture, 3:1 | | 5 |
| | | | 5 |

The tables show that by pretreating the Skin Pad with a solution of an initiator in 2-propanol (cf. entry nos. 3, 4, 7, 8, 11, 12, 15, 16), the curing time of the cyanoacrylate-based adhesive composition can be decisively improved in every case. This effect is particularly evident when 2-octyl cyanoacrylate is used as the cyanoacrylate monomer. Pretreatment of the surface results in a very definite reduction in curing time (compare entry nos. 1, 2 with 3, 4); the use of 2-propanol results in a simultaneous disinfection of the corresponding adhesion region.

By adding a quaternary ammonium compound (QAC, 0.5 wt %) to the initiator solution 1 or 2, the curing time of the cyanoacrylate-based adhesive composition could be reduced by up to 20% and disinfection of the corresponding adhesive region was improved.

1. A kit for topical and/or internal application of a polymerizable adhesive composition to tissue of mammals, containing, in one or more separate containers:
a) a composition having a disinfecting action that encompasses at least one component that is selected from the group of the polymerization initiators and is suitable for initiating and/or accelerating polymerization of the polymerizable adhesive composition on the tissue surface, and
b) a polymerizable adhesive composition.

2. The kit according to claim 1, wherein the polymerizable adhesive composition contains, as one component, a cyanoacrylate monomer according to formula (I) or a mixture of a cyanoacrylate monomer according to formula (I) with further cyanoacrylates, R being a substituted or unsubstituted, straight-chain, branched or cyclic allyl, alkoxyalkyl, alkyl, alkenyl, haloalkyl, or alkinyl group that encompasses 1 to 18 C atoms, and/or contains an aromatic group or acyl group.

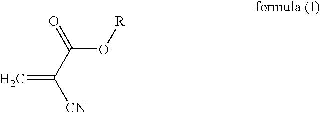

3. The kit according to one of the preceding claims, wherein R is selected from the following groups: allyl, beta-methoxyethyl, methyl, ethyl, n-propyl, isopropyl, n-butyl, isobutyl, n-pentyl, isopentyl, cyclopentyl, n-hexyl, isohexyl, cyclohexyl, n-heptyl, isoheptyl, cycloheptyl, methoxyisopropyl, ethoxyethyl, isopropoxyethyl, 2-butoxyethyl, n-octyl, 1-octyl, 2-octyl, 3-octyl, 4-octyl, decyl, dodecyl, or lactoyl.

4. The kit according to claim 1, wherein the composition having a disinfecting action contains as a disinfecting component one or more organic alcohols, the weight proportion of the organic alcohol based on the total quantity of the composition having a disinfecting action being at least 80%.

5. The kit according to claim 1, wherein the organic alcohol is selected from ethanol, n-propanol, isopropanol, n-butanol, 2-butanol, isobutanol, 1,3-butanediol, phenoxyethanol, 1,2-propylene glycol, and glycerol, and from mixtures of the aforesaid alcohols.

6. The kit according to claim 1, wherein the composition having a disinfecting action is present in the form of a liquid, as a gel, as a suspension, or as a paste.

7. The kit according to claim 1, wherein the polymerization initiator is dispersed and/or dissolved at room temperature in the composition having a disinfecting action.

8. The kit according to claim 1, wherein the polymerization initiator has a pKₐ value≧5.

9. The kit according to claim 8, wherein the pKₐ value of the polymerization initiator is between 5 and 30.

10. The kit according to claim 1, wherein the polymerization initiator has a pKₐ value of less than 5 but possesses a sufficiently high nucleophilic nature to initiate polymerization of the polymerizable adhesive composition on the tissue surface.

11. The kit according to claim 1, wherein the polymerization initiator is selected from aluminates, borates, carbonates, bicarbonates, carboxylates, hydroxides, halides, oxides, sulfonates, sulfates, stearates, pyrazines, amino acids, nucleophilic nonionic amines, amides, acetates, phosphines, phosphites, ammonium compounds, or nonionic surfactants, and from mixtures of the polymerization initiators recited.

12. The kit according to claim 12, wherein the polymerization initiator is selected from the following substances or mixtures of said substances: ammonium acetate, sodium bicarbonate, calcium bicarbonate, sodium carbonate, calcium carbonate, diethyl carbonate, sodium stearate, calcium stearate, polyethylene glycol stearate, pyrazine, 2,3-dimethoxypyrazine, 2,3-dimethylpyrazine, trimethylpyrazine, arginine, histidine, phenylalanine, serine, sodium salicylate, caffeine, dimethylparatoluidine, urea, tetrabutylammonium acetate, triphenylphosphine, triethyl phosphite, ethyldiphenylphosphonite, 2-methoxypyridine, 2,2-dipyridyl disulfide, 3,5-dichloropyridine, 3,5-dibromopyridine, 4-cyanopyridine, domiphen bromide, nutyrylcholine chloride, benzylalkonium bromide, benzylalkonium chloride, acetylquinoline chloride, dimethyldioctylammonium chloride/bromide, dimethyldidecylammonium chloride/bromide, dimethyldidodecyl-ammonium chloride/bromide, polysorbate.

13. The kit according to claim 1, wherein at least one of the compositions making up the kit additionally contains one or more antimicrobial active substances, by preference selected from the groups of the aldehydes, antimicrobial acids, carboxylic acid esters, acid amides, phenols, phenol derivatives, diphenyls, diphenylalkanes, urea derivatives, oxygen and nitrogen acetals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propynylbutyl-carbamate, iodine, iodophores, peroxides, p-hydroxybenzoic acid esters, by preference selected from the methyl, ethyl, and propyl esters.

14. The kit according to claim 1, wherein the composition having a disinfecting action contains one or more antimicrobial active substances selected from Betadine®, chlorhexidine, and quaternary ammonium compounds (QACs).

15. The kit according to claim 1, wherein the polymerization initiator possesses an antimicrobial action.

16. The kit according to claim 1, wherein the polymerization initiator is a quaternary ammonium compound (QAC).

17. The kit according to claim 1, wherein at least one further component, selected from the groups of the plasticizers, thickening agents, stabilizers, skin-care active substances, perfumes, wound healing agents, coloring substances, heat-dissipating reagents, and/or primers, is contained.

18. The kit according to claim 1, wherein the polymerizable adhesive composition has been sterilized using the following methods or combinations of the following methods: heat, ultrafiltration, irradiation.
